(19) United States
(12) Patent Application Publication
(10) Pub. No.: US 2019/0078536 A1
(43) Pub. Date: Mar. 14, 2019

(54) FLOW PATH SPLITTER FOR TURBOFAN GAS TURBINE ENGINES

(71) Applicant: Rolls-Royce North American Technologies Inc., Indianapolis, IN (US)

(72) Inventor: Benjamin M. Iwrey, Indianapolis, IN (US)

(21) Appl. No.: 15/701,811

(22) Filed: Sep. 12, 2017

(51) Int. Cl. F02K 1/66; F02C 3/04; F02K 3/06; F04D 29/36; F04D 29/54

(52) U.S. Cl. CPC F02K 1/66; F02C 3/04; F05D 2220/323; F04D 29/362; F04D 29/545; F02K 3/06

(57) ABSTRACT

A turbofan gas turbine engine according to the present disclosure includes an engine core, a variable pitch fan, and a fan flow bifurcation with a flow path splitter ring that divides a bypass duct from an engine core inlet. The variable pitch fan is driven by the engine core and has movable fan blades that are reconfigurable to provide forward or reverse thrust. The fan flow bifurcation is arranged between the variable pitch fan and the engine core and is configured to interact with air flow when the fan blades are set to forward or reverse thrust.

### FIELD OF THE DISCLOSURE

The present disclosure relates generally to gas turbine engines, and more specifically to aerodynamic structures included in turbofan gas turbine engines.

### BACKGROUND

Gas turbine engines are used to power aircraft, watercraft, power generators, and the like. Gas turbine engines typically include an engine core with a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide some thrust in certain designs.

Some gas turbine engines, called turbofan engines, include a fan mounted forward of the compressor and driven by the turbine to create thrust. In such designs, some air discharged from the fan is directed into the compressor for use in the engine core and some air discharged from the fan is directed into a bypass around the engine core. Ducts and various other structures can be included in turbofan engines to guide air moving through the fan.

### SUMMARY

The present disclosure may comprise one or more of the following features and combinations thereof.

A turbofan gas turbine engine according to the present disclosure includes a fan and an engine core coupled to the fan to drive the fan. The fan included in the engine is, more specifically, a variable pitch fan having fan blades that are moveable between a forward-thrust position and a reverse-thrust position. In the forward-thrust position, the fan blades are configured to discharge air aft, toward and around the engine core to provide forward thrust. Forward thrust can be used for an aircraft propulsion the aircraft during takeoff, flight, and taxi. In the reverse-thrust position, the fan blades are configured to discharge air forward, toward the fan inlet face for reverse thrust. Reverse thrust is used, usually, to slow down a landing aircraft.

In illustrative embodiments, the turbofan gas turbine engine also includes a fan flow bifurcation arranged between the fan and the engine core. The fan flow bifurcation is configured to interact with air flow when the fan blades are set to forward- or reverse-thrust positions. The fan flow bifurcation has a splitter ring arranged to separate an engine core inlet from a bypass duct that extends around the engine core. The fan flow bifurcation also includes airfoils that redirect/smooth air flow moving into the engine core and into the bypass duct.

In illustrative embodiments, at least some of the leading edge of the splitter ring is arranged aft of the leading edge of the airfoils. Accordingly, air moving in a forward direction through the bypass duct when the fan blades are in the reverse-thrust position need not interact with the leading edge of the airfoils to enter the engine core. Avoiding interaction with the leading edge of the airfoils can lead to more core stability margin and efficient operation of the engine when the fan blades are in the reverse-thrust position.

In illustrative embodiments, some or all of the airfoils included in the fan flow bifurcation are arranged forward of the splitter ring so that all of the leading edge of the splitter ring is arranged aft of the leading edge of the airfoils. In illustrative embodiments, the splitter ring may be scalloped such that a portion of the leading edge of the splitter ring is arranged aft of the leading edge of the airfoils at the location of the scallops.

These and other features of the present disclosure will become more apparent from the following description of the illustrative embodiments.

### BRIEF DESCRIPTION OF THE DRAWINGS

FIG. 1 is a perspective view of a turbofan gas turbine engine according to the present disclosure in which, the engine is cut away to show that the engine includes (i) a variable pitch fan that is reconfigurable to provide forward or reverse thrust, (ii) an engine core configured to drive the variable pitch fan, and (iii) a fan flow bifurcation arranged between the variable pitch fan and the engine core to interact with gasses moving into the engine core when the variable pitch fan is providing forward or reverse thrust;

FIG. 2 is a simplified cross-sectional view of a portion of the engine of FIG. 1 showing that the fan flow bifurcation includes a splitter ring arranged to separate an engine core inlet from a bypass duct that extends around the engine core and integrated airfoils that radially intersect the splitter ring, and showing that the integrated airfoils have a leading edge located forward of a leading edge of the splitter ring so that air moving in a forward direction through the bypass duct when the variable pitch fan provides reverse thrust need not move forward of the leading edge of the integrated airfoil to enter the engine core inlet as suggested by the dashed-line arrows in FIG. 2;

FIG. 3 is a simplified cross-sectional view of a portion of an engine like that of FIGS. 1 and 3 showing that an alternative fan flow bifurcation includes a splitter ring and airfoils, and showing that the airfoils have leading and trailing edges located forward of a leading edge of the splitter ring so that air moving in a forward direction through the bypass duct when the variable pitch fan provides reverse thrust need not interact with the airfoils to enter the engine core inlet;

FIG. 4 is a is a perspective view of a second turbofan gas turbine engine according to the present disclosure in which the engine is cut away to show that the engine includes (i) a variable pitch fan, (ii) an engine core configured to drive the variable pitch fan, and (iii) a fan flow bifurcation with a scalloped splitter ring arranged radially between outlet guide vanes and engine section stators;

FIG. 5 is a simplified cross-sectional view of a portion of the engine of FIG. 4 showing that the scallops in the splitter ring cause a portion of a leading edge of the splitter ring to be located aft of the leading edge of the outlet guide vanes and the engine section stators so that air moving in a forward direction through the bypass duct when the plurality of fan blades are in the reverse-thrust position need not move forward of the leading edge of the airfoils to enter the engine core inlet;

FIG. 6 is a perspective view of a portion of the fan flow bifurcation from FIGS. 4 and 5 showing the scallops formed in the splitter ring circumferentially between associated airfoil locations; and

FIG. 7 is a cross-sectional view of FIG. 6 showing that the leading edge of the splitter ring is located axially aft of the leading edge of the associated airfoils at the scallop locations.

### DETAILED DESCRIPTION

For the purposes of promoting an understanding of the principles of the disclosure, reference will now be made to a number of illustrative embodiments illustrated in the drawings and specific language will be used to describe the same.

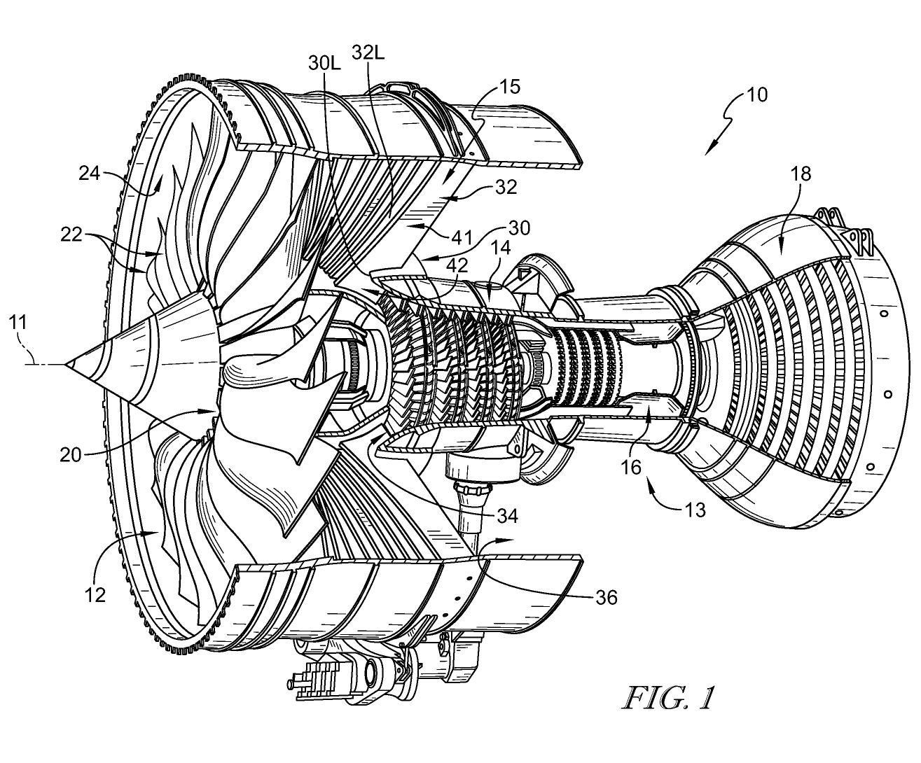

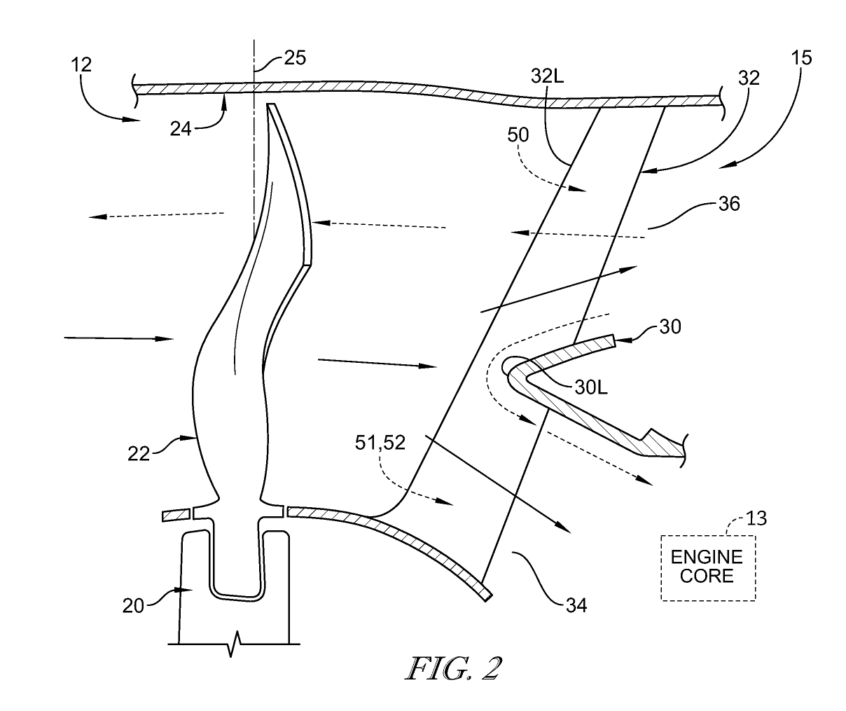

An illustrative turbofan gas turbine engine 10 adapted for use in an air vehicle such as in an airplane is shown in FIG. 1. The engine 10 includes a fan 12, an engine core 13 coupled to the fan 12 to drive the fan 12, and a fan flow bifurcation 15 arranged between the fan 12 and the engine core 13. The fan 12 is illustratively a variable pitch fan and is driven by the turbine 18 to provide forward or reverse thrust. The fan flow bifurcation 15 is configured to interact with air flow when the fan 12 is set to provide both forward and reverse thrust as suggested in FIG. 2.

As noted above, the fan 12 in the illustrative engine 10 is a variable pitch fan that is reconfigurable to provide either forward or reverse thrust as suggested by arrows in FIG. 2. The fan 12 includes a disk 20 mounted to rotate about a central axis, a plurality of fan blades 22 that extend outwardly from the disk 20, and a fan case 24 that extends around the fan blades 22. The fan blades 22 are mounted to rotate about respective axes 25 from a forward-thrust position to a reverse-thrust position. In the forward-thrust position, the fan blades 22 are configured to discharge air aft, toward and around the engine core 13 to provide forward thrust as suggested by the solid arrows in FIG. 2. In the reverse-thrust position, the fan blades 22 are configured to discharge air forward, toward the fan inlet face 13 for reverse thrust as suggested by dash line arrows in FIG. 2

The engine core 13 illustratively includes a compressor 14, a combustor 16, and a turbine 18 as shown in FIG. 1. The compressor 14 compresses and delivers air to the combustor 16. The combustor 16 mixes fuel with the compressed air received from the compressor 14 and ignites the fuel. The hot, high-pressure products of the combustion reaction in the combustor 16 are directed into the turbine 18 to cause the turbine 18 to rotate about a central axis 11 and drive the compressor 14 and the fan 12.

The fan flow bifurcation 15 is arranged axially between the variable pitch fan 12 and the engine core 13 as shown in FIGS. 1 and 2. The fan flow bifurcation 15 includes a flow splitter ring 30 and a plurality of circumferentially spaced apart airfoils 32. The splitter ring 30 is arranged to separate an engine core inlet 34 from a bypass duct 36 located radially outward of and around the engine core 13. The airfoils 32 extend inward from the fan case 24 and through the bypass duct 36 and the engine core inlet 34 to interact with air moving into the engine core inlet 34 and the bypass duct 36.

In the illustrative embodiment, the airfoils 32 have a leading edge 32L located forward of a leading edge 30L of the splitter ring 30 as suggested in FIG. 2. Accordingly, air moving in a forward direction through the bypass duct 36 when the fan blades 22 are in the reverse-thrust position need not all move forward of and need not all interact with the leading edge 32L of the airfoils 32 to enter the engine core inlet 34. Avoiding interaction with the leading edge 32L of the airfoils 32 can lead to more core stability margin and efficient operation of the engine 10 when the fan blades 22 are in the reverse-thrust position.

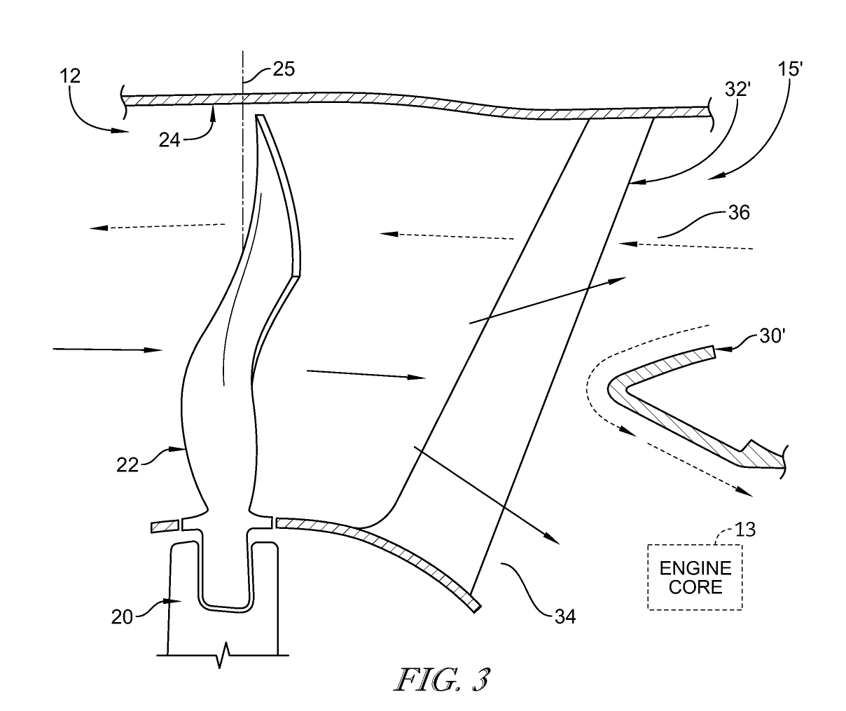

The exemplary flow splitter ring 30 is constructed such that the airfoils 32 intersect with the splitter ring 30 as shown in FIGS. 1 and 2. However in alternative embodiments, like that shown in FIG. 3, a fan flow bifurcation 15′ may include a splitter ring 30′ and airfoils 32′ that are spaced axially apart from one another. Other features of fan flow bifurcation 15′ may be similar to features of fan flow bifurcation 15. In such alternative embodiments, the airfoils 32′ are located axially forward of the splitter ring 30′ such that air moving in a forward direction through the bypass duct 36 when the fan blades 22 are in the reverse-thrust position need not all move forward of and need not all interact with the airfoils 32′ to enter the engine core inlet 34. Avoiding interaction with the airfoils 32′ can lead to more core stability margin and efficient operation of the engine 10 when the fan blades 22 are in the reverse-thrust position.

In the illustrative embodiment, the airfoils 32 are integrated airfoils in that each airfoil 32 includes an outlet guide vane portion 41 and an engine section stator portion 42 as shown in FIG. 2. The outlet guide vane portion 41 extends radially outward from the splitter ring 30 to the fan case 24. The engine section stator portion 42 extends radially inward from the splitter ring 30 across the engine core inlet 34 to an inner wall 38 of the fan flow bifurcation 15. In addition, the airfoils 32 are illustratively integrated into the entire fan flow bifurcation 15 as they are integrally formed from composite materials with the splitter ring 30 and the inner wall 38. Accordingly, joints between the components of the fan flow bifurcation 15 are provided by matrix material and/or reinforcement material included in the composite material of the fan flow handle 15. In other embodiments, the components of the fan flow bifurcation 15 may be separately constructed and coupled together using various means.

The fan flow bifurcation 15 of the exemplary embodiment is arranged directly aft of the fan blades 22 as shown in FIGS. 1 and 2. Accordingly, the airfoils 32 of the fan flow bifurcation 15 are the first structure to interact with air discharged from the fan 12 when the fan blades 22 are in the forward-thrust position.

At least one of the airfoils 32 included in the exemplary fan flow bifurcation 15 is hollow to control weight of the airfoil 32 and to provide a passageway 50 into the engine 10 as suggested in FIG. 2. In illustrative embodiments, a structural support 51 configured to support the engine 10 relative to an associated airframe may be housed within the hollow airfoil 32. In illustrative embodiments, accessory lines extend through the hollow airfoil 32 from the fan case 24 to radially inward of the engine core inlet 34.

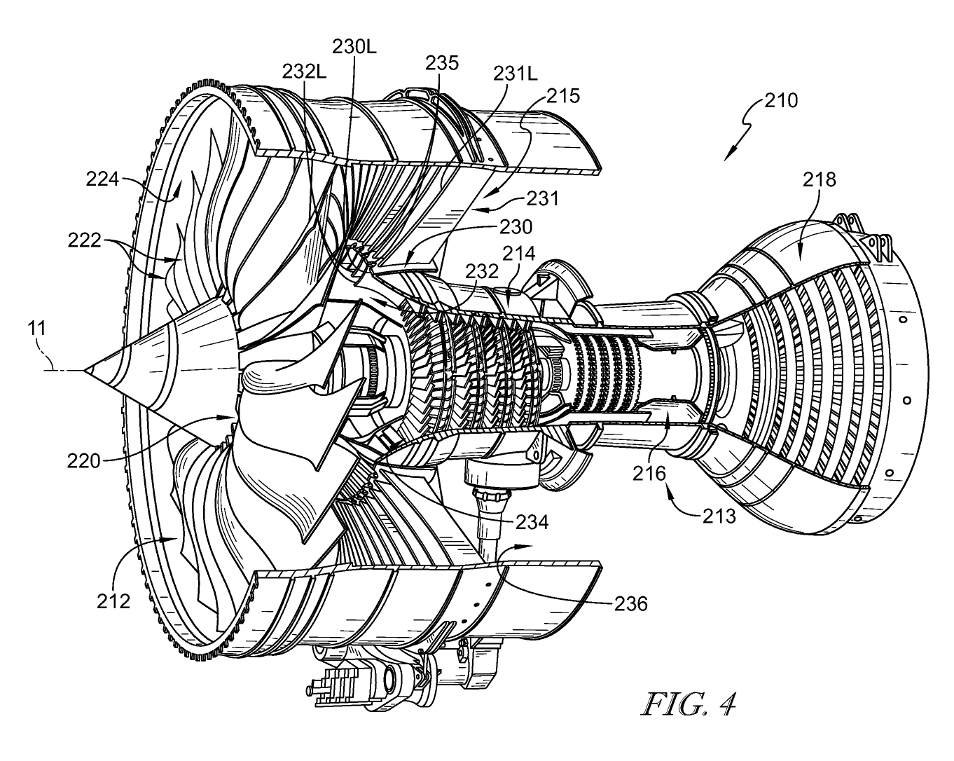

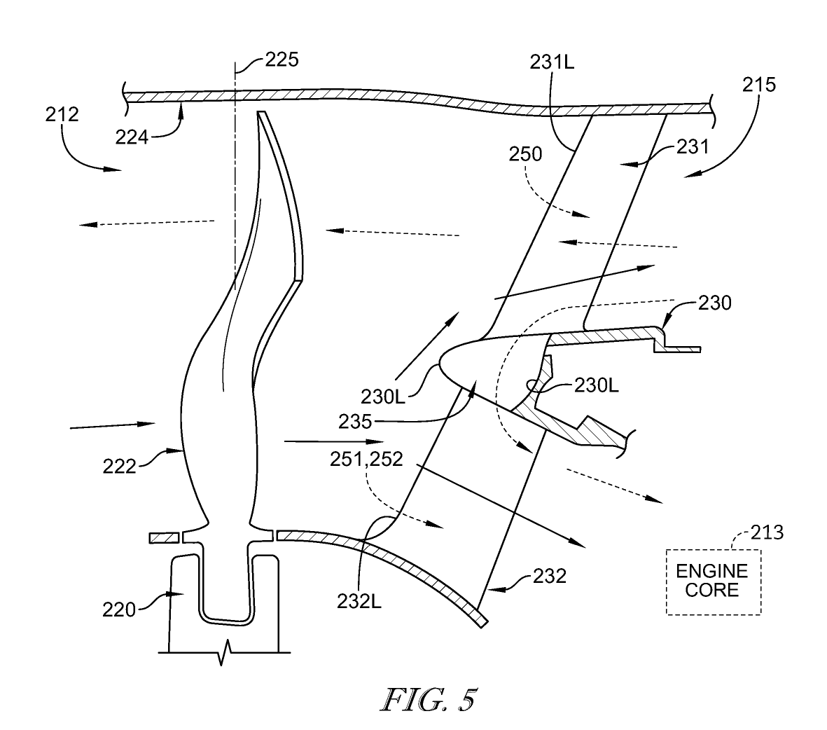

A second turbofan gas turbine engine 210 along with another fan flow handle 215 adapted for use with a variable pitch fan 212 is shown in FIGS. 4-7. The engine 210 includes a variable pitch fan 212, an engine core 213 coupled to the fan 212 to drive the fan 212, and a fan flow bifurcation 215 arranged between the fan 212 and the engine core 213. The fan 212 is a variable pitch fan configured to provide forward or reverse thrust. The fan flow bifurcation 215 is configured to interact with air flow when the fan 212 is set to provide both forward and reverse thrust as suggested in FIG. 5.

The fan 212 includes a disk 220 mounted to rotate about a central axis, a plurality of fan blades 222 that extend outwardly from the disk 220, and a fan case 224 that extends around the fan blades 222 as shown in FIGS. 4 and 5. The fan blades 222 are mounted to rotate about respective axes 225 from a forward-thrust position to a reverse-thrust position. In the forward-thrust position, the fan blades 222 are configured to discharge air aft, toward and around the engine core 213 to provide forward thrust as suggested by the solid arrows in FIG. 5. In the reverse-thrust position, the fan blades 222 are configured to discharge air forward, toward the fan inlet face 213 for reverse thrust as suggested by dash line arrows in FIG. 5

The engine core 213 illustratively includes a compressor 214, a combustor 216, and a turbine 218 as shown in FIG. 4. The compressor 214 compresses and delivers air to the combustor 216. The combustor 216 mixes fuel with the compressed air received from the compressor 214 and ignites the fuel. The hot, high-pressure products of the combustion reaction in the combustor 16 are directed into the turbine 218 to cause the turbine 218 to rotate about a central axis 211 and drive the compressor 214 and the fan 212.

The fan flow bifurcation 215 is arranged axially between the variable pitch fan 212 and the engine core 213 as shown in FIGS. 4 and 5. The fan flow bifurcation 215 includes a flow splitter ring 230, outlet guide vanes 231, and engine section stators 232. The splitter ring 230 is arranged to separate an engine core inlet 234 from a bypass duct 236 located radially outward of and around the engine core 213. The outlet guide vanes 231 extend radially outward from the splitter ring 230 to the fan case 224. The engine section stators 232 extend radially inward from the splitter ring 230 across the engine core inlet 234.

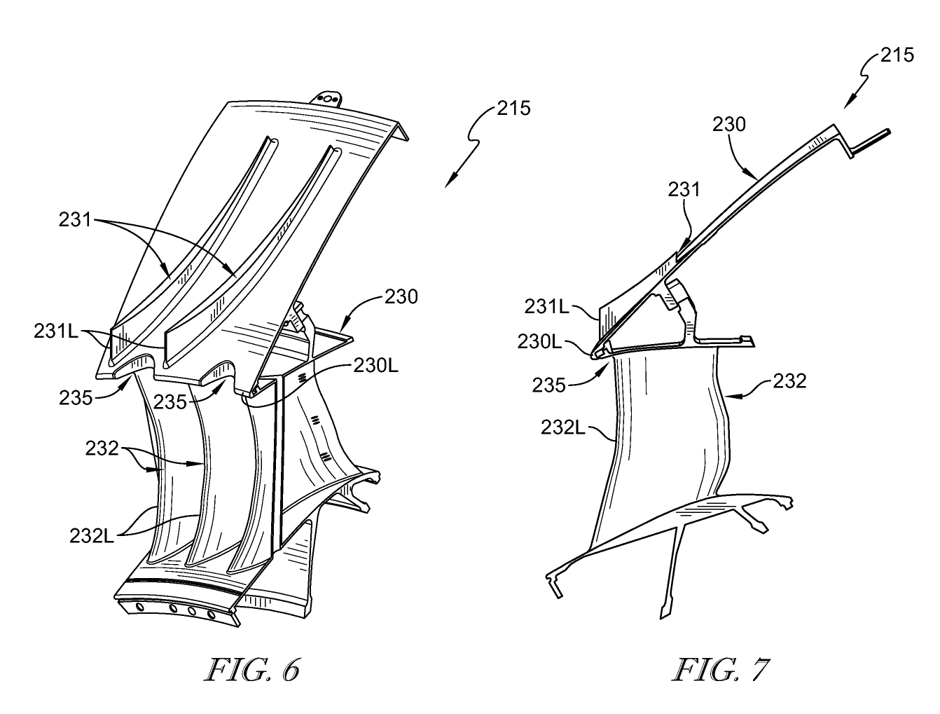

In the illustrated example, the splitter ring 230 is formed to include scallops 235 along a leading edge 230L of the splitter ring 230 as shown in FIGS. 5 and 6. The scalloped portion of the leading edge 230L of the splitter ring 230 is located aft of a leading edge 231 L of the outlet guide vanes 231 and aft of a leading edge 232L of the engine section stators 232. Accordingly, air moving in a forward direction through the bypass duct 236 when the fan blades 222 are in the reverse-thrust position need not all move forward of and need not all interact with the leading edges 231L, 232L of the airfoils 231, 232 to enter the engine core inlet 234. Avoiding interaction with the leading edge 231L, 232L of the airfoils 231, 232 can lead to more efficient operation of the engine 210 when the fan blades 222 are in the reverse-thrust position.

The exemplary embodiment shows that the forward-most portion of the leading edge 230L of the splitter ring 230 is located forward of the leading edge 231 L, 232L of the outlet guide vanes 231 and the engine section stators 232. In this example, the leading edges 231 L, 232L of the airfoils 231, 232 can be coupled to and supported by the splitter ring 230.

The airfoils 231, 232 are illustratively assembled into the fan flow bifurcation 215 as part of a multi-piece assembly as suggested in FIGS. 5-7. However, in other embodiments, the fan flow bifurcation 215 may be partially or fully integrally formed from composite material.

The fan flow bifurcation 215 of the exemplary embodiment is arranged directly aft of the fan blades 222 as shown in FIGS. 4 and 5. Accordingly, the fan flow bifurcation 215 is the first structure to interact with air discharged from the fan 212 when the fan blades 222 are in the forward-thrust position.

Airfoils 231,232 included in the exemplary fan flow bifurcation 215 may be hollow to control weight and to provide a passageway 250 into the engine 10. In illustrative embodiments, a structural support 251 configured to support the engine 210 relative to an associated airframe may be housed within the hollow airfoils 231, 232. In illustrative embodiments, accessory lines extend through the hollow airfoils 231, 232 from the fan case 224 to radially inward of the engine core inlet 234.

Fan flowpaths in turbofan engines often bifurcate downstream of the fan rotor (or rotors) by means of a splitter. Integral to the inboard ‘core’ stream is typically an ESS (Engine Section Stator), which removes swirl introduced by the rotor and directs flow to the engine core compressor. Integral to the outboard ‘bypass’ stream is typically an OGV (Outlet Guide Vane), which removes swirl introduced by the rotor and directs flow to the bypass nozzle.

In variable-pitch fan architecture, the fan rotor blades may be rotated about a radial axis such that flow is drawn through the bypass nozzle and discharged through the fan inlet to provide reverse thrust operation. In order to maintain engine power, a fraction of the bypass air must be drawn into the core from the bypass during reverse thrust operation. The outlet guide vane is often designed such that, in reverse flow operation, swirl is introduced to swirl-free flow. The flow is then drawn inboard radially around the splitter in designs where the splitter extends forward of the outlet guide vane, where further swirl is introduced due to conservation of angular momentum. The core stream can then impact the engine section stator at high negative incidence in designs where the splitter extends forward of the engine section stator, likely inducing a negative-incidence separation. The consequences of this can potentially range from reduced core power to deep surge and core damage.

According to the present disclosure, an integrated Splitter-OGV-ESS may be designed such that the airfoil section transitions smoothly between the OGV and ESS sections, while the leading edge extends some distance upstream of the splitter nose. In reverse thrust operation, the splitting streamline dividing the discharge and core streams is positioned upstream of the splitter nose and the airfoil leading edge. During the course of reverse thrust operation, the OGV section introduces some swirl into the core stream, but the core stream never extends past the OGV/ESS leading edge. In the process of being drawn into the core itself, the ‘partial’ swirl is removed by the ESS section. The negative incidence problem can be thus avoided by obviating incidence. The module can also serve as a bypass strut, avoiding the weight, length and complexity associated with including a separate structural member.

According to embodiments of the present disclosure, a fan flow bifurcation may have a single OGV-ESS located entirely upstream of the splitter. This allows bypass air to flow into the core with reduced or no swirl.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A turbofan gas turbine engine, the engine comprising
an engine core including a compressor, a combustor, and a turbine,
a variable pitch fan coupled to the engine core to be driven by the turbine, the variable pitch fan including a disk mounted to rotate about a central axis, a plurality of fan blades that extend outwardly from the disk, and a fan case that extends around the fan blades, wherein the fan blades are mounted to rotate from a forward-thrust position configured to discharge air aftward toward and around the engine core for forward thrust to a reverse-thrust position configured to discharge air forward toward the fan inlet face for reverse thrust, and
a fan flow bifurcation arranged aft of the variable pitch fan and forward of the engine core, the fan flow bifurcation including a splitter ring arranged to separate an engine core inlet from a bypass duct that extends around the engine core and a plurality of integrated airfoils that interact with air moving into the engine core inlet and the bypass duct, wherein the integrated airfoils intersect the splitter ring and each of the integrated airfoils have a leading edge located forward of a leading edge of the splitter ring so that air moving in a forward direction through the bypass duct when the plurality of fan blades are in the reverse-thrust position need not move forward of the leading edge of the integrated airfoil to enter the engine core inlet.

2. The engine of claim 1, wherein each of the plurality of integrated airfoils include an outlet guide vane portion that extends radially outward from the splitter ring to the fan case and an engine section stator portion that extends radially inward from the splitter ring.

3. The engine of claim 2, wherein the fan flow bifurcation is arranged directly aft of the plurality of fan blades such that the plurality of integrated airfoils are the first structure to interact with air discharged from the variable pitch fan when the plurality of fan blades are in the forward-thrust position.

4. The engine of claim 2, wherein at least one of the integrated airfoils is a hollow integrated airfoil and a structural support configured to support the engine relative to an associated airframe is housed within the hollow integrated airfoil.

5. The engine of claim 2, wherein at least one of the integrated airfoils is a hollow integrated airfoil and accessory lines extend radially through the hollow integrated airfoil from the fan case to radially inward of the engine core inlet.

6. The engine of claim 1, wherein the fan flow bifurcation comprises composite materials and a joint formed between at least one of the plurality of integrated airfoils and the splitter ring includes composite matrix materials.

7. A turbofan gas turbine engine, the engine comprising
an engine core including a compressor, a combustor, and a turbine,
a variable pitch fan coupled to the engine core, the variable pitch fan including a fan case and a plurality of fan blades mounted to move from a forward-thrust position configured to discharge air aftward toward and around the engine core for forward thrust to a reverse-thrust position configured to discharge air forward away from the engine core for reverse thrust, and
a fan flow bifurcation arranged aft of the variable pitch fan and forward of the engine core, the fan flow bifurcation including a splitter ring arranged to separate an engine core inlet from a bypass duct around the engine core and a plurality of airfoils each have a leading edge located forward of at least a portion of a leading edge of the splitter ring so that air moving in a forward direction through the bypass duct when the plurality of fan blades are in the reverse-thrust position need not move forward of the leading edge of the airfoil to enter the engine core inlet.

8. The engine of claim 7, wherein each of the plurality of airfoils extend radially inward from the fan case through the engine core inlet.

9. The engine of claim 8, wherein the plurality of airfoils intersect with the splitter ring.

10. The engine of claim 9, wherein each of the plurality of integrated airfoils include an outlet guide vane portion that extends radially outward from the splitter ring to the fan case and an engine section stator portion that extends radially inward from the splitter ring.

11. The engine of claim 8, wherein the plurality of airfoils each have a trailing edge located forward of the leading edge of the splitter ring.

12. The engine of claim 11, wherein the flow bifurcation is arranged directly aft of the plurality of fan blades such that the plurality of airfoils are the first structure to interact with air discharged from the variable pitch fan when the plurality of fan blades are in the forward-thrust position.

13. The engine of claim 12, wherein at least one of the integrated airfoils is a hollow airfoil and a structural support configured to support the engine relative to an associated airframe is housed within the hollow integrated airfoil.

14. The engine of claim 12, wherein at least one of the integrated airfoils is a hollow integrated airfoil and accessory lines extend radially through the hollow integrated airfoil from the fan case to radially inward of the engine core inlet.

15. The engine of claim 12, wherein the compressor includes variable inlet guide vanes each mounted for movement to vary the attack angle of the variable inlet guide vanes, and the variable inlet guide vanes are arranged directly aft of the plurality of airfoils such that the variable inlet guide vanes are the first aerodynamic structure to interact with air moving past the leading edge of the splitter ring into the engine core inlet.

16. A turbofan gas turbine engine, the engine comprising
an engine core including a compressor, a combustor, and a turbine,
a variable pitch fan coupled to the engine core, the variable pitch fan including a fan case and a plurality of fan blades mounted to move from a forward-thrust position configured to discharge air aftward toward and around the engine core for forward thrust to a reverse-thrust position configured to discharge air forward away from the engine core for reverse thrust, and
a fan flow bifurcation arranged aft of the variable pitch fan and forward of the engine core, the fan flow bifurcation including a splitter ring arranged to separate an engine core inlet from a bypass duct around the engine core, outlet guide vanes that extends radially outward from the splitter ring to the fan case, and engine section stators that extends radially inward from the splitter ring across the engine core inlet, wherein at least a portion of a leading edge of the splitter ring is located aft of a leading edge of the outlet guide vanes so that air moving in a forward direction through the bypass duct when the plurality of fan blades are in the reverse-thrust position need not move forward of the leading edge of the outlet guide vanes to enter the engine core inlet.

17. The engine of claim 16, wherein at least a portion of a leading edge of the splitter ring is located aft of a leading edge of the engine section stators so that air moving in a forward direction through the bypass duct when the plurality of fan blades are in the reverse-thrust position need not move forward of the leading edge of the engine section stators to enter the engine core inlet.

18. The engine of claim 16, wherein the splitter ring is formed to include scallops along a leading edge of the splitter ring and only a scalloped portion of the leading edge of the splitter ring is located aft of a leading edge of the outlet guide vanes.

19. The engine of claim 18, wherein the forward-most portion of the leading edge of the splitter ring is located forward of the leading edge of the outlet guide vanes.

20. The engine of claim 18, wherein the forward-most portion of the leading edge of the splitter ring is located forward of the leading edge of the engine section stators.
